(19) United States
(12) Patent Application Publication
(10) Pub. No.: US 2012/0042709 A1
(43) Pub. Date: Feb. 23, 2012

(54) PEX CLAMP FASTENING TOOL

(75) Inventor: Jeffrey Alexander Polofsky, Matthews, NC (US)

(73) Assignee: CONBRACO INDUSTRIES, INC., Pageland, SC (US)

(21) Appl. No.: 12/861,142

(22) Filed: Aug. 23, 2010

(51) Int. Cl. B25B 7/12; B21D 39/04

(52) U.S. Cl. 72/409.01; 81/364

(57) ABSTRACT

A clamp fastening tool including first and second handles pivotally connected at a common pivot point, first and second jaw members pivotally connected to the handles and independently pivotally interconnected through a common jaw connector, a ratchet pivotally connected at the common pivot point between the first and second handles, and an adjustable set screw threadably engaged in a sidewall of the first handle for adjusting the position of the ratchet with respect to the first handle.

### TECHNICAL FIELD AND BACKGROUND OF THE INVENTION

1. Field of the Invention

The present invention relates generally to the field of tools configured for use with cross-linked polyethylene (“PEX”) tubing and accessories, and more particularly, to a tool for fastening PEX tubing clamps including a ratchet for controlling operational movement of the clamping jaws of the tool through handle movement, and a set screw recessed in the handle of the tool for adjusting the position of the ratchet and thus the amount of travel of the handles to provide a tool for fastening clamps of varying dimension.

2. Background of the Invention

Known to those skilled in the art, PEX tubing is commonly used in plumbing applications as an alternative to polyvinylchloride (“PVC”) and copper pipe. Uses of PEX tubing include general plumbing applications, hydronic radiant heating systems, water piping and insulation systems, and the general transportation of fluids and slurries, among other uses. PEX tubing is commonly terminated in a fitting requiring a clamp fastened over the tubing for ensuring sealing engagement of the tubing and fitting.

While clamp fastening tools are known in the art, conventional tool designs either do not include means for adjusting the ratchet mechanism to accommodate clamps of varying size, or include cumbersome adjustment mechanisms difficult to operate or that do not give a clear indication of ratchet mechanism position. Accordingly, the present invention is directed to a PEX clamp fastening tool that provides adjustability of the ratchet while overcoming the disadvantages of prior art tool designs.

### BRIEF SUMMARY OF THE INVENTION

In one aspect, an adjustable clamping tool for fastening (i.e. “closing”) an ear-type PEX tubing clamp is provided herein.

In another aspect, the tool includes first and second handles operationally connected to first and second jaw members, respectively, wherein opening and closing of the handles causes simultaneous opening and closing of the jaw members, however to a lesser degree.

In another aspect, the first and second jaw members each define a first end pivotally connected to their respective handle and a second free end terminating in a clamping jaw.

In another aspect, the first and second handles are interconnected at one end at a common pivot point, the first and second jaw members are pivotally connected about their first end to their respective handle, and the first and second jaw members are independently pivotally interconnected through a common jaw connector, wherein closing of the handles causes simultaneous closing of the jaw members.

In another aspect, the tool further includes a ratchet pivotally carried on the common pivot point and between the handles for controlling the operational travel between the handles.

In another aspect, the ratchet includes a toothed member pivotally moveable with respect to the first and second handles, and a pawl carried on one of the handles for engaging the toothed member to permit movement of the handles in only the closing direction when the pawl is engaged with the teeth of the toothed member.

In another aspect, the pawl is spring biased to maintain a predetermined angle of the pawl with respect to the teeth of the toothed member.

In another aspect, the toothed member includes a clearance adjacent the series of teeth for clearing the pawl upon full closing of the handles to provide automatic release of the ratchet.

In another aspect, the first handle defines an internally threaded opening through a sidewall thereof receiving an externally threaded set screw for adjusting through contact the position of the toothed member with respect to the first handle.

In another aspect, advancing the set screw in the first handle in the direction toward the second handle urges the toothed member apart from the first handle.

In another aspect, withdrawing the set screw from the first handle in the direction away from the second handle returns the toothed member toward the first handle.

In another aspect, the set screw defines head geometry corresponding to that of a screwdriver for facilitating turning of the set screw.

To achieve the foregoing and other aspects and advantages, a PEX clamp fastening tool is provided herein including first and second handles pivotally connected at a common pivot point, first and second jaw members pivotally connected to the first and second handles, respectively, and independently pivotally interconnected through a common jaw connector, each of the first and second jaw members defining a free end terminating in a clamping jaw, a ratchet pivotally connected at the common pivot point and positioned between the first and second handles, and an adjustable set screw threadably engaged in an opening through a sidewall of the first handle for physically contacting the ratchet to adjust the position of the ratchet with respect to the first handle.

In a further embodiment, the ratchet includes a toothed member having a series of teeth and a pawl carried on the second handle for engaging the series of teeth to permit movement of the first and second handles in only a closing direction when the pawl is engaged with the teeth.

In a further embodiment, the set screw physically contacts a sidewall of the toothed member to urge the toothed member apart from the first handle when the set screw is advanced in the opening in a direction toward the second handle, and return the toothed member toward the first handle when the set screw is withdraw from the opening in the direction away from the second handle.

In a further embodiment, the pawl is biased in a direction toward the first handle to maintain a predetermined orientation of an engaging portion of the pawl with respect to the series of teeth.

In a further embodiment, the toothed member further defines a clearance adjacent the series of teeth for clearing engagement of the toothed member with the pawl upon complete closing of the first and second handles.

In a further embodiment, the set screw is recessed in the sidewall of the first handle and defines head geometry corresponding to screwdriver geometry for facilitating turning of the set screw.

In a further embodiment, each of the first and second jaw members are pivotally connected at a first end to their respective handle, are pivotally connected to the jaw connector at about their mid-span, and terminate at a second free end in a clamping jaw such that closing of the first and second handles causes simultaneous closing of the first and second jaw members.

Additional features and advantages of the invention will be set forth in the detailed description which follows, and in part will be readily apparent to those skilled in the art from that description or recognized by practicing the invention as described herein.

### BRIEF DESCRIPTION OF THE DRAWINGS

These and other features, aspects and advantages of the present invention are better understood when the following detailed description of the invention is read with reference to the accompanying drawings, in which:

FIG. 1 is a perspective view of the PEX clamp fastening tool in accordance with an embodiment of the invention;

FIG. 2 is an alternate perspective view of the tool of FIG. 1 detailing the set screw;

FIG. 3 is a detailed perspective view of the tool of FIG. 1 showing ratchet adjustment;

FIG. 4 is a detailed view of the tool of FIG. 1 showing the ratchet disengaged;

FIG. 5 is a detailed view of the tool of FIG. 1 showing the ratchet engaged; and

FIG. 6 is a detailed view of the tool of FIG. 1 showing the ratchet disengaged.

### DETAILED DESCRIPTION OF THE INVENTION

The present invention will now be described more fully hereinafter with reference to the accompanying figures in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

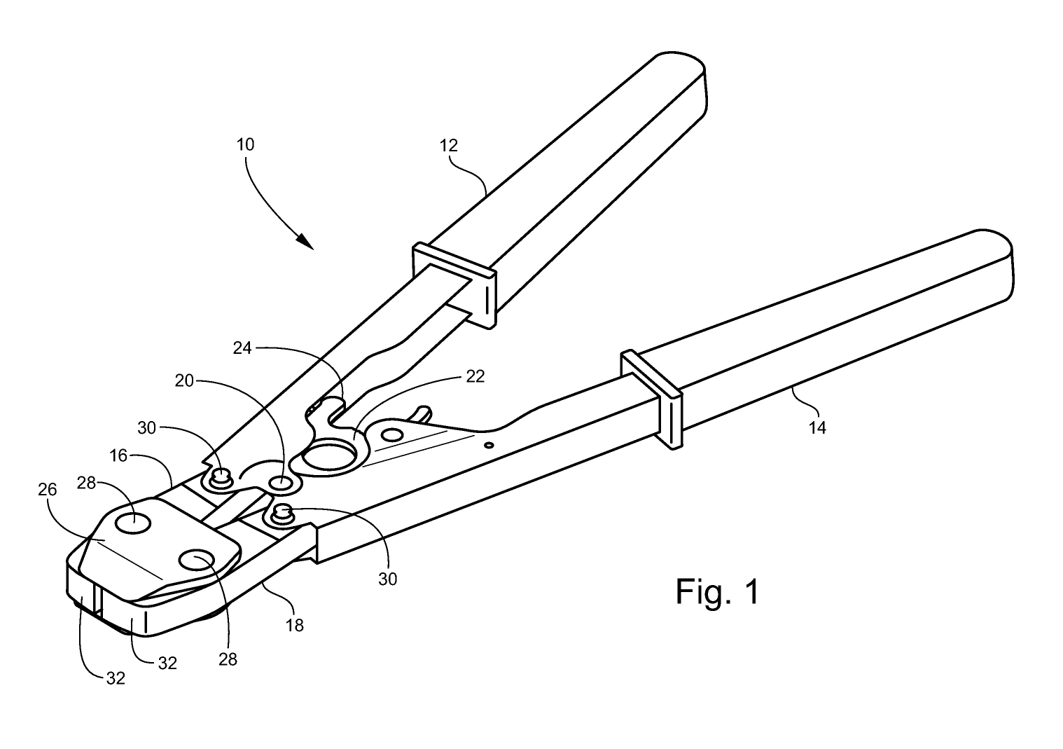

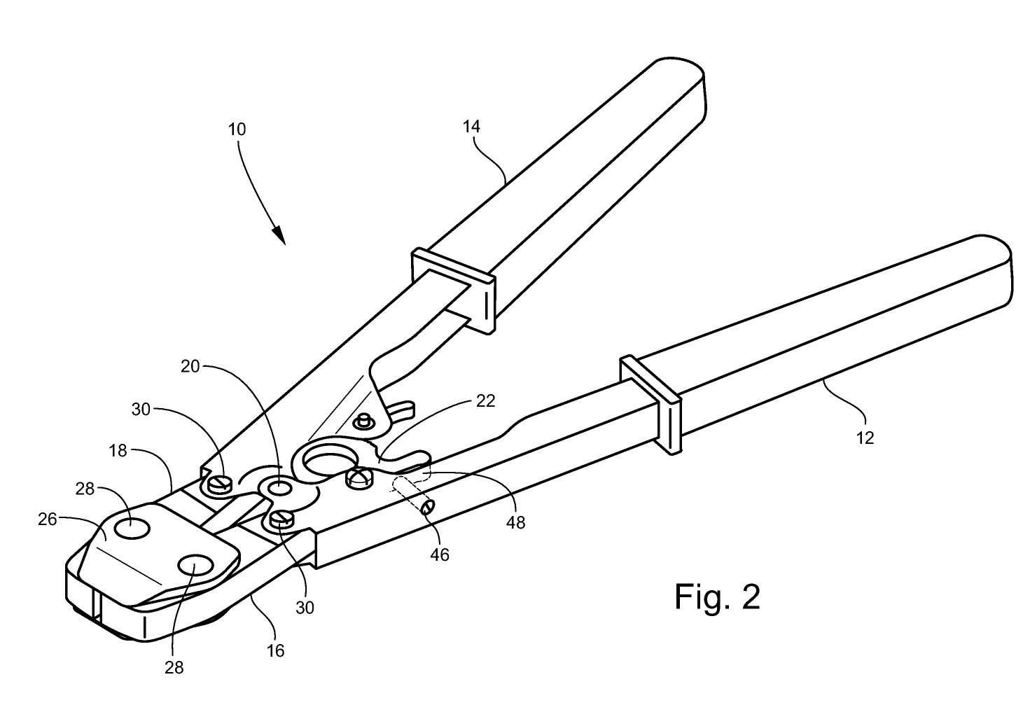

Referring to the figures, an adjustable clamping tool for fastening (i.e. “closing”) an ear-type PEX tubing clamp is provided herein. Referring specifically to FIGS. 1-2, the clamping tool 10 generally includes first and second handles 12, 14 operationally connected to first and second jaw members 16, 18, respectively, wherein opening and closing of the handles causes simultaneous opening and closing of the jaw members, however to a lesser degree. First and second handles 12, 14 are pivotally interconnected through common pivot point 20, which additionally pivotally carries a toothed member 22 of a ratchet 24 between the first and second handles 12, 14 and adjustable in position relative thereto as described in detail below.

The first and second handles 12, 14 are interconnected at one end through the common pivot point 20. The first and second jaw members 16, 18 are pivotally connected about their first end to their respective handle, and are also independently pivotally interconnected through a common jaw connector 26. Thus, the first and second jaw members 16, 18 are each pivotally connected to the jaw connector 26 at pivot points 28 to allow them to pivot relative thereto in response to movement of the first and second handles 12, 14. The jaw connector 26, with one jaw connector 26, preferably provided on each “side” of the tool 10, locks the first and second jaw members 16, 18 together. Each of the jaw members 16, 18 terminates at a first free end in a pivotal connection with its handle at pivot point 30, and at a second free end in a clamping jaw 32.

Each of the first and second handles 12, 14 generally define an elongate channel for cooperatively receiving the ratchet 24 therein when the handles 12, 14 are in their “closed” configuration, i.e. brought together. As used herein, the term “opened” or “opening” is intended to describe the act pulling the handles 12, 14 apart, and the term “closed” or “closing” is intended to describe the act of bringing the handles 12, 14 together. The tool 10 is closed to fasten a PEX clamp. The tool is opened to release a fastened PEX clamp to a degree sufficient to clear the ears of the fastened clamp.

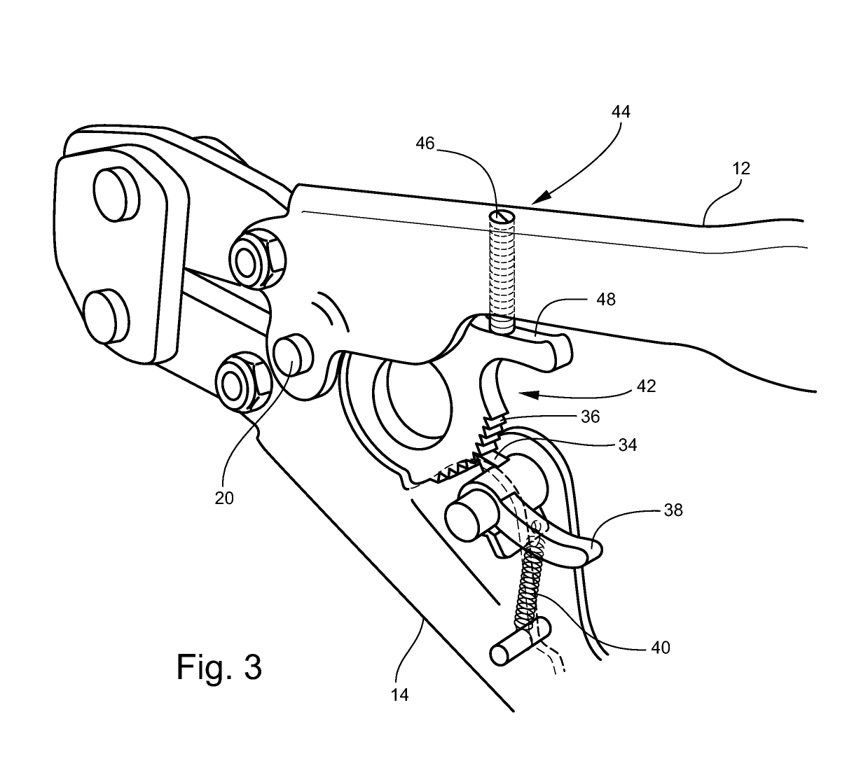

Referring specifically to FIGS. 3-6, the tool 10 includes a ratchet 24 generally including a toothed member 22 pivotally carried on the common pivot point and associated with the first handle 12, and a pawl 34 rotatable carried on the second handle 14 for engaging a series of teeth 36 of the toothed member 22. The ratchet 24 permits movement of the handles 12, 14 in only the closing direction when the pawl 34 is engaged with the teeth 36 of the toothed member 22. The pawl 34 may be released without traversing the entire series of teeth 36 by slightly closing the handles 12, 14 to a degree sufficient to actuate trigger 38 of pawl 34 to release pawl 34. Pawl 34 is biased, i.e. spring biased as shown with spring 40, such that engagement portion of pawl 34 is positioned for locking engagement when disengaged and tool 10 is open.

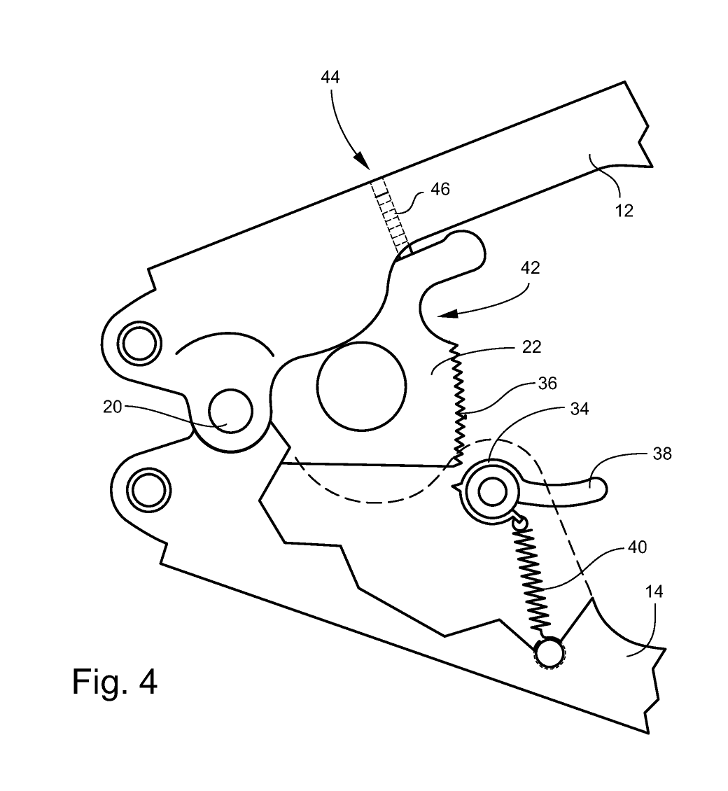

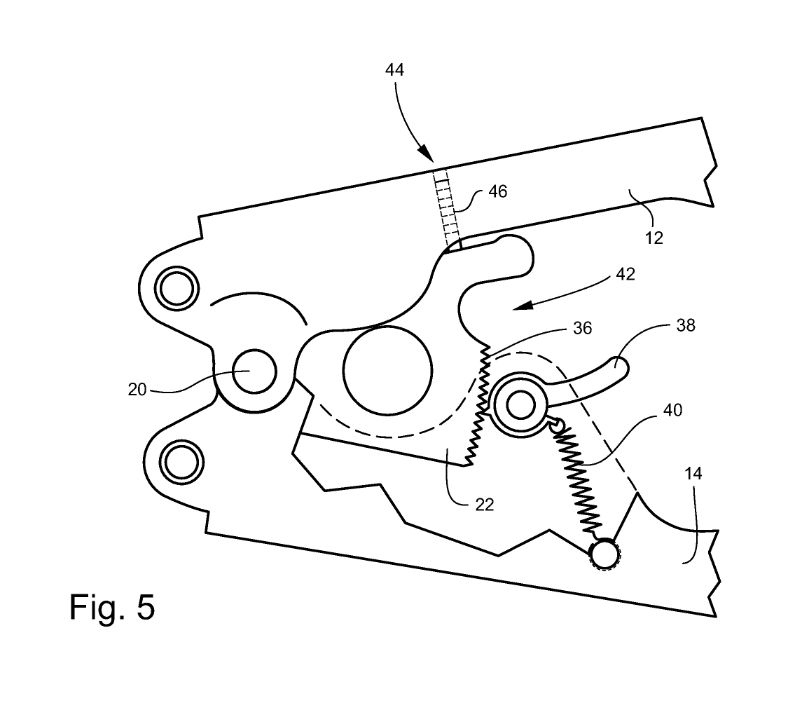

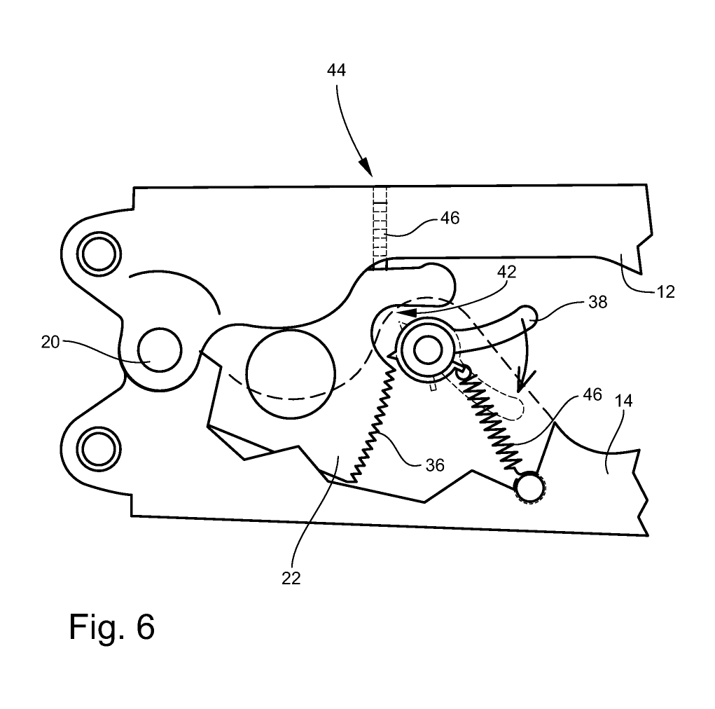

The toothed member 22 includes a series of teeth 36 defining a generally linear path along which the pawl 34 travels as the handles are closed to prevent opening. The toothed member 22 further defines a clearance 42 at the end of the tooth path for clearing engagement with the pawl 34 when the tool is fully functionally closed, thus providing an auto-release feature that in cooperation with the biasing spring 40 positions pawl 34 such that it does not lock in engagement with the teeth 36 when the tool is opened and the pawl 34 passes back over the teeth 36. Referring specifically to FIGS. 3 and 5, the ratchet is shown engaged with pawl 34 engaging teeth 36. Referring specifically to FIG. 4, the tool 10 is shown open with pawl 34 disengaged from teeth 36. Referring specifically to FIG. 6, the tool 10 is shown closed with pawl 34 positioned in the clearance 42 of the toothed member 22 and thus disengaged.

Referring to FIGS. 2-6, the first handle 12 of tool 10 defines an internally threaded opening 44 through a sidewall thereof that receives an externally threaded set screw 46 for adjusting through contact the position of the toothed member 22 with respect to the first handle 12. It is envisioned that alternative set screw positions, such as mounting on either handle, can be practiced while achieving the same functionality of ratchet adjustment without departing from the scope of the invention. The opening 44 not only receives and threadably engages the set screw 46, but also provides access for turning the screw to adjust the position of the toothed member 22 with respect to at least the first handle 12. Set screw 46 preferably defines head geometry for engaging a screwdriver or other tool for facilitating turning of the set screw 46. The head of set screw 46 may be recessed within the opening 44 or protrude from the opening. The position of the set screw 46, such as the head of the set screw, relative to the opening or entrance of the opening can be used to determine the appropriate set screw position for a predetermined clamp size. For example, a fully withdrawn set screw with its head apart from the sidewall may indicate a first position for a predetermined clamp size, while a head flush against the sidewall may indicate a second position for a different clamp size from the first.

Set screw 46 physically contacts a sidewall 48 of the toothed member 22 such that advancing the set screw 46 in the opening 44 in the first handle 12 in the direction toward the second handle 14 urges the toothed member 22 apart from the first handle 12, and withdrawing the set screw 46 from the opening 44 in the first handle 12 in the direction away from the second handle 14 returns the toothed member 22 toward the first handle 12. Compared with conventional adjustment assemblies, adjustment of the toothed member 22 is accomplished with only the single set screw 46.

The ratchet, through the adjustment of toothed member 22 provides adjustability in the travel of the clamping jaws 32 of the first and second jaw members 16, 18 to accommodate a variety of clamp sizes.

While a PEX clamp fastening tool has been described herein with reference to specific embodiments and examples, it is envisioned that various details of the invention may be changed without departing from the scope of the invention. Furthermore, the foregoing description of the preferred embodiments of the invention and best mode for practicing the invention are provided for the purpose of illustration only and not for the purpose of limitation.

What is claimed is:

1. A clamp fastening tool, comprising:
first and second handles pivotally connected at a common pivot point;
first and second jaw members pivotally connected to the first and second handles, respectively, and independently pivotally interconnected through a common jaw connector, each of the first and second jaw members defining a free end terminating in a clamping jaw;
a ratchet pivotally connected at the common pivot point and positioned between the first and second handles; and
an adjustable set screw threadably engaged in an opening through a sidewall of the first handle for physically contacting the ratchet to adjust the position of the ratchet with respect to the first handle.

2. The clamp fastening tool according to claim 1, wherein the ratchet comprises a toothed member having a series of teeth and a pawl carried on the second handle for engaging the series of teeth to permit movement of the first and second handles in only a closing direction when the pawl is engaged with the teeth.

3. The clamp fastening tool according to claim 2, wherein the set screw physically contacts a sidewall of the toothed member to urge the toothed member apart from the first handle when the set screw is advanced in the opening in a direction toward the second handle, and return the toothed member toward the first handle when the set screw is withdraw from the opening in the direction away from the second handle.

4. The clamp fastening tool according to claim 2, wherein the pawl is biased in a direction toward the first handle to maintain a predetermined orientation of an engaging portion of the pawl with respect to the series of teeth.

5. The clamp fastening tool according to claim 2, wherein the toothed member further defines a clearance adjacent the series of teeth for clearing engagement of the toothed member with the pawl upon complete closing of the first and second handles.

6. The clamp fastening tool according to claim 1, wherein the set screw is recessed in the sidewall of the first handle.

7. The clamp fastening tool according to claim 1, wherein the set screw defines head geometry corresponding to screwdriver geometry for facilitating turning of the set screw.

8. The clamp fastening tool according to claim 1, wherein each of the first and second jaw members are pivotally connected at a first end to their respective handle, are pivotally connected to the jaw connector at about their mid-span, and terminate at a second free end in a clamping jaw.

9. The clamp fastening tool according to claim 1, wherein closing of the first and second handles causes simultaneous closing of the first and second jaw members.

10. A clamp fastening tool, comprising:
first and second handles pivotally connected through a common pivot point;
first and second jaw members pivotally connected to the first and second handles, respectively, and independently pivotally interconnected through a common jaw connector;
a ratchet pivotally connected at the common pivot point and positioned between the first and second handles, the ratchet comprising a toothed member and a pawl carried on the second handle for engaging a series of generally linearly arranged teeth of the toothed member; and
a set screw adjustably received in an opening through a sidewall of the first handle for adjusting the position of the toothed member with respect to the first handle.

11. The clamp fastening tool according to claim 10, wherein the set screw physically contacts a sidewall of the toothed member to urge the toothed member apart from the first handle when the set screw is advanced in the opening in a direction toward the second handle, and return the toothed member toward the first handle when the set screw is withdraw from the opening in a direction away from the second handle.

12. The clamp fastening tool according to claim 10, wherein the pawl is biased in a direction toward the first handle to maintain a predetermined orientation of an engaging portion of the pawl with respect to the series of teeth.

13. The clamp fastening tool according to claim 10, wherein the toothed member further defines a clearance adjacent the series of teeth for clearing engagement of the toothed member with the pawl upon complete closing of the first and second handles.

14. The clamp fastening tool according to claim 10, wherein the set screw is recessed in the sidewall of the first handle.

15. The clamp fastening tool according to claim 10, wherein the set screw defines head geometry corresponding to screwdriver geometry for facilitating turning of the set screw.

16. The clamp fastening tool according to claim 10, wherein each of the first and second jaw members are pivotally connected at a first end to their respective handle, are pivotally connected to the jaw connector at about their mid-span, and terminate at a second free end in a clamping jaw.

17. The clamp fastening tool according to claim 10, wherein closing of the first and second handles causes simultaneous closing of the first and second jaw members.
